(19) United States
(12) Patent Application Publication
(10) Pub. No.: US 2001/0043277 A1
(43) Pub. Date: Nov. 22, 2001

(54) Electronic camera

(75) Inventors: Toshiyuki Tanaka, Nishinomiya-Shi (JP); Yasuhiro Morimoto, Takatsuki-Shi (JP); Hiroaki Kubo, Muko-Shi (JP); Masahito Niikawa, Sakai-Shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD.,

(21) Appl. No.: 09/834,165

(22) Filed: Apr. 12, 2001

(30) Foreign Application Priority Data
Apr. 18, 2000 (JP) P2000-116538

(51) Int. Cl. H04N 5/222

(52) U.S. Cl. 348/333.01; 348/333.12; 348/371

(57) ABSTRACT

This electronic camera changes display characteristics (such as brightness, contrast, and hue) of an image displayed on an electronic view finder (EVF) in accordance with characteristics (such as brightness and hue) of environment light. For example, as the brightness of environment light increases, the brightness of an image displayed on the EVF is reduced, or the hue of an image displayed on the EVF is changed in a direction opposite to that of changing the hue of the environment light. By the operation, the display characteristics of an image displayed on the EVF can be optimized in accordance with the characteristics of the environment light. By automatically displaying a live view on the EVF when the brightness of the environment light is high or displaying a pre-light emission image captured with a flash, the display states of the LCD and EVF are optimized.

This application is based on application No. 2000-116538 filed in Japan, the contents of which are hereby incorporated by reference.

### BACKGROUND OF THE INVENTION

1. Field of the Invention

The present invention relates to a technique of optimizing a display mode in a display such as an electronic view finder (EVF) or liquid crystal display (LCD) in an electronic camera in according to a using condition.

2. Description of the Background Art

Some digital cameras (electronic cameras) have an electronic view finder (EVF). The electronic view finder can electronically display a captured image and has the function corresponding to an optical finder in an optical camera. By carrying out “live view display” for displaying images of the subject which are continuous with respect to time on the electronic view finder, the user can capture an image while checking an image of the subject to be captured (presumed image).

In many cases, such a digital camera has not only the electronic view finder but also a relatively large liquid crystal display (LCD) on its rear face or the like. By similarly carrying out the live view display on the liquid crystal display as well, the user can capture an image while checking an image of the subject to be captured.

In the display on the electronic view finder, however, an influence of environment light is not considered. The technique has a problem such that display characteristics of an image displayed on the electronic view finder influenced by environment light are not optimized.

Also in the case where there are two kinds of displays (such as electronic view finder and liquid crystal display), the displays are simply manually switched to display an image. There is a problem that the display mode is not optimized according to using conditions including the environment light.

### SUMMARY OF THE INVENTION

According to a first aspect of the invention, an electronic camera includes: a display for displaying an image of a subject; a detector for detecting environment light; and a corrector for correcting an image displayed on the display by changing a display characteristic of the image displayed on the display in accordance with a state of the environment light detected by the detector. Since the display characteristics of an image displayed on the display are changed according to environment light, an easy-to-see image can be displayed on the display.

According to a second aspect of the invention, an electronic camera includes: a first display capable of electrically displaying a captured image; a second display capable of electrically displaying a captured image in a display mode different from that of the first display; a detector for detecting a state of environment light; and a controller for changing a display state of at least one of said first and second displays in accordance with the state of the environment light detected by the detector. Since the display state of at least one of the first and second displays is changed according to the environment light, the display states of the first and second displays can be optimized, and the easy operability can be improved.

According to a third aspect of the invention, there is provided an electronic camera capable of emitting flash light with which a subject is irradiated, having: an image pickup device for capturing an image of the subject; a first display capable of electrically displaying the image of the subject captured by the image pickup device; a second display capable of electrically displaying the image of the subject captured by the image pickup device in a display mode different from that of the first display; and a controller for controlling display on the first and second displays, wherein the controller displays the image of the subject irradiated with the flash light onto the first display, and displays the image of the subject captured by the image pickup device onto the second display in predetermined cycles. A pre-light emission image captured with a flash using light emitting means is displayed on the first display, and a live view image is displayed on the second display. Consequently, the display modes in the first and second displays at the time of capturing an image with a flash are optimized, and easy operability can be improved.

According to a fourth aspect of the invention, there is provided an electronic camera including: a first display capable of electrically displaying a captured image; a second display capable of electrically displaying the captured image in a display mode different from that of the first display; and an adjuster for adjusting a gain of an image displayed on the first display and a gain of an image displayed on the second display, wherein the adjuster amplifies the image displayed on the first display by a first gain and amplifies the image displayed on the second display by a second gain different from the first gain. A captured image is displayed with the first gain on the first display, and a captured image is displayed with a second gain on the second display. The display modes in the first and second displays are therefore optimized and the easy operability can be improved.

A first object of the invention is to provide an electronic camera capable of optimizing display characteristics of an image displayed on an electronic view finder in accordance with environment light.

A second object of the invention is to provide an electronic camera having two kinds of displays whose display modes can be optimized.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a digital camera according to a preferred embodiment of the invention.

FIG. 2 is a cross section taken along line II-II of FIG. 1.

FIG. 3 is a rear view of the digital camera.

FIG. 4 is a functional block diagram of the digital camera.

FIG. 5 is a block diagram showing the internal configuration of an overall control unit.

FIG. 6 is a diagram for explaining storage of an image into a memory card.

FIG. 7 is a diagram for explaining adjustment of brightness.

FIG. 8 is a diagram for explaining adjustment of contrast.

FIG. 9 is a diagram showing switching of the display modes of an LCD (Liquid Crystal Display) and EVF (electronic View Finder).

FIG. 10 is a diagram showing another switching of the display modes of the LCD and the EVF.

FIG. 11 is a diagram showing a state where recommendation is indicated on the LCD.

FIG. 12 is a timing chart showing display modes of the LCD and the EVF.

FIG. 13 is a diagram showing a display mode of the LCD and that of the EVF in a predetermined period T1.

### DESCRIPTION OF THE PREFERRED EMBODIMENTS

A. First Preferred Embodiment

A1. Configuration of Main Portion of Digital Camera

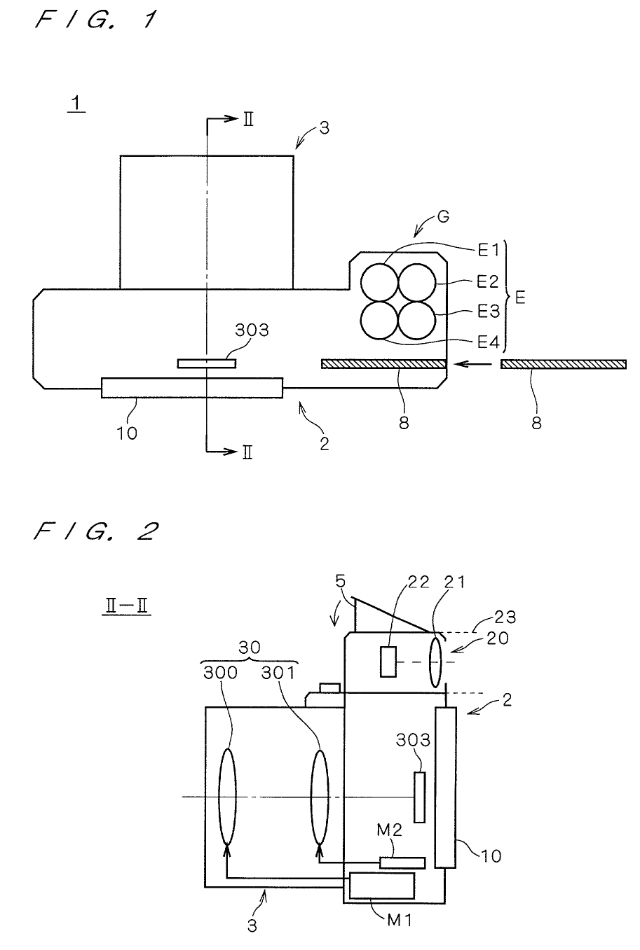

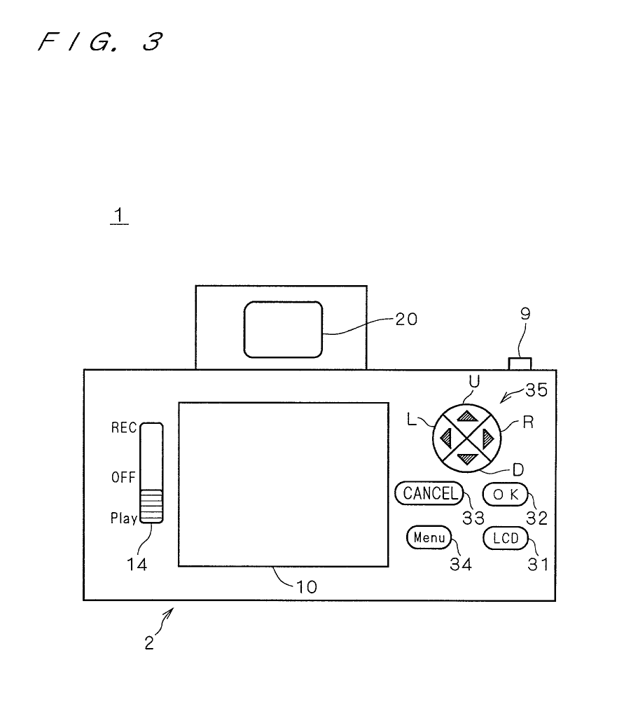

FIGS. 1 to 3 are diagrams each showing the configuration of a main portion of a digital camera 1 according to a first embodiment of the invention. FIG. 1 is a plan view. FIG. 2 is a cross section taken along ling II-II of FIG. 1. FIG. 3 is a rear view. The drawings are not always triangular diagrams and their principal objective is to conceptually show the configuration of the main portion of the digital camera 1.

As shown in the drawings, the digital camera 1 has a camera body 2 of an almost rectangular parallelepiped outer shape and an image capturing section 3 for capturing an image of the subject and the like. The image capturing section 3 is provided in the portion projected to the front side (left side in FIG. 2) from the camera body 2 and in the camera body 2.

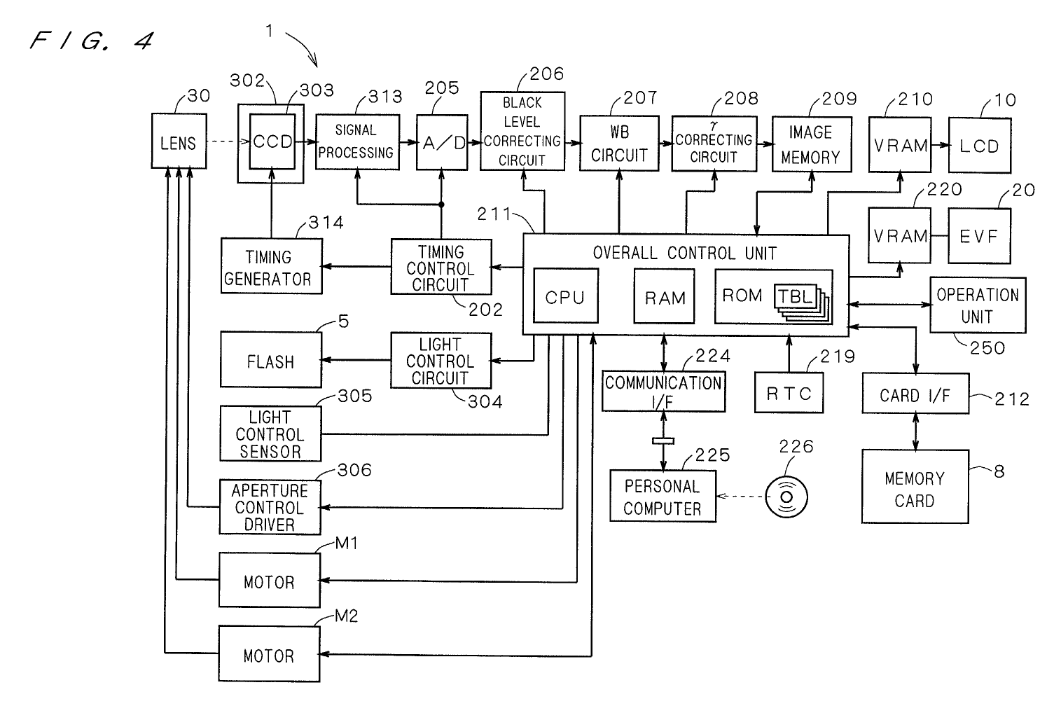

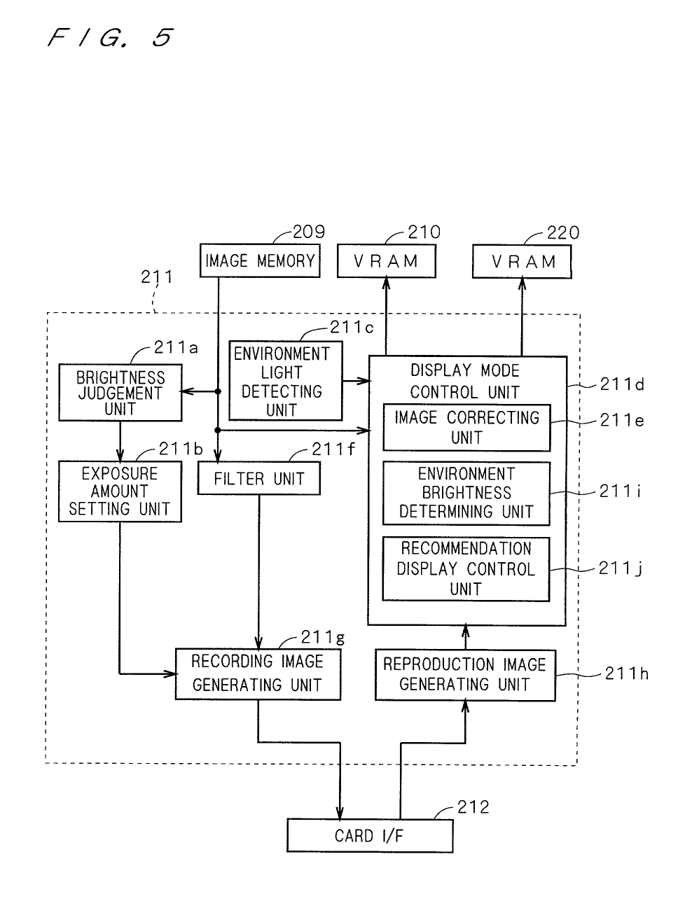

In the image capturing section 3, an image capturing circuit 302 (refer to FIG. 4) having a CCD color area sensor 303 is provided at an appropriate position backward of a group 30 of lenses for image capturing with a macro function. The lens group 30 includes a zoom lens 300 and a focusing lens 301.

In the camera body 2, a zoom motor M1 for changing the zoom ratio of the zoom lens 300 and moving the zoom lens 300 between a housed position and an image capturing position, and a motor M2 for driving the focusing lens 301 to achieve focus are provided.

A grip G is provided on the front face of the camera body 2 and a built-in pop-up flash 5 is provided in an appropriate position at an upper end of the camera body 2. A shutter button 9 is provided on the top face of the camera body 2.

As shown in FIG. 3, on the rear face of the camera body 2, a liquid crystal display (hereinbelow, also called “LCD”) 10 for performing “live view display” of captured images, playback display of a recorded image, and the like in an almost center, and an electronic view finder (hereinbelow, also called “EVF”) 20 are provided. On the LCD 10 and the EVF 20, an image is displayed in color.

In the EVF 20, an image displayed on a display such as a relatively small LCD 22 is enabled to be seen via an ocular 21. In the EVF 20, light shielding performance is increased by providing a light shielding member such as an eyepiece cap 23 (shown by a broken line in FIG. 2) between an eye of the user and the ocular 21 (FIG. 2) of the EVF 20.

On the rear face of the camera body 2, an image capturing/playback mode setting switch 14 for switching and setting a mode between an “image capturing mode” and a “playback mode” is provided. The image capturing mode is a mode of taking a picture, and the playback mode is a mode of playing back and displaying a captured image recorded in a memory card 8 onto the LCD 10.

A four-way switch 35 is provided on the right side of the rear face of the digital camera 1. By pressing buttons L and R, the zoom motor M1 drives to perform zooming. By using the buttons U, D, L, and R, various operations are carried out.

On the rear face of the camera body 2, an LCD button 31, an “OK” button 32, a “cancel” button 33, and a menu button 34 are provided. The LCD button 31 is a button used to turn on/off the LCD or EVF. Each time the LCD button 31 is pressed, the on/off state of the LCD display or EVF display is switched (this will be described in detail hereinlater).

As shown in FIG. 1, the memory card 8 is inserted into the digital camera 1. The digital camera 1 operates on a power battery E in which four AA cells E1 to E4 are connected in series as a power source.

A2. Functional Blocks of Digital Camera

FIG. 4 is a functional block diagram of the digital camera 1. In FIG. 4, the CCD (image pickup device) 303 photoelectric-converts an optical image of the subject formed by the lens group 30 into image signals of color components of R (red), G (green), and B (blue) (signals each of which is a signal train of pixel signals received by pixels), and outputs the image signals. A timing generator 314 generates various timing pulses for controlling the driving of the CCD 303.

An exposure control in the image capturing section 3 is performed by adjusting the aperture of the lens group 30 by an aperture control driver 306 and adjusting the exposure amount of the CCD 303, that is, charge accumulation time of the CCD 303 corresponding to the shutter speed. When the brightness of the subject is low and proper shutter speed cannot be set, by adjusting the level of the image signal outputted from the CCD 303, improper exposure due to insufficient exposure is corrected. That is, at the time of low brightness, the exposure control is performed by a combination of the shutter speed and gain adjustment. The level of the image signal is adjusted by adjusting the gain of an AGC circuit in a signal processing circuit 313.

The timing generator 314 generates a drive control signal for the CCD 303 on the basis of a reference clock transmitted from the timing control circuit 202. The timing generator 314 generates clock signals such as timing signals of start/end of integration (start/end of exposure) and read control signals of photoreception signals of pixels (horizontal synchronizing signal, vertical synchronizing signal, transfer signal, and the like), and outputs the signals to the CCD 303.

The signal processing circuit 313 performs a predetermined analog signal process on the image signal (analog signal) outputted from the CCD 303. The signal processing circuit 313 has a CDS (correlation double sampling) circuit and an AGC (automatic gain control) circuit, reduces noises in the image signal by the CDS circuit, and adjusts the gain of the AGC circuit, thereby adjusting the level of the image signal.

A light control circuit 304 controls the light emission amount of the built-in flash 5 at the time of image capturing with flash to a predetermined light emission amount set by an overall control unit 211. At the time of image capturing with flash, reflection light of flash light from the subject is received by a light control sensor 305. When the photoreception amount reaches a predetermined light emission amount, a light emission stop signal is outputted from the light control circuit 304, light emission of the built-in flash 5 is forcedly stopped in response to the light emission stop signal, thereby controlling the light emission amount of the built-in flash 5 to a predetermined light emission amount.

An A/D converter 205 converts each of the pixel signals of the image signal to a 12-bit digital signal. The A/D converter 205 converts each pixel signal (analog signal) to a 12-bit digital signal on the basis of clocks for A/D conversion supplied from the timing control circuit 202.

The timing control circuit 202 for generating clocks to the timing generator 314 and A/D converter 205 is provided. The timing control circuit 202 is controlled by a reference clock in the overall control unit 211.

A black level correcting circuit 206 corrects the black level of the A/D converted pixel signal to a reference black level. A WB (white balance) circuit 207 converts the level of pixel data of each of the color components R, G, and B. The WB circuit 207 converts the level of the pixel data of each of the color components R, G, and B by using a level conversion table supplied from the overall control unit 211. A parameter (gradient of characteristic) of each of the color components in the level conversion table is automatically or manually set for each captured image.

A γ correcting circuit 208 corrects the gradation of pixel data. An image memory 209 is a memory for storing pixel data outputted from the γ correcting circuit 208. The image memory 209 has a storage capacity of one frame. That is, the image memory 209 has a storage capacity of pixel data of (1600×1200) pixels corresponding to the number of pixels of the CCD 303, and each pixel data is stored in a corresponding pixel position.

An LCD VRAM 210 is a buffer memory of image data to be displayed on the LCD 10. The LCD VRAM 210 has a storage capacity of image data corresponding to the number of pixels (400×300) of the LCD 10.

An EVF VRAM 220 is a buffer memory of image data to be displayed on the EVF 20. The EVF VRAM 220 has a storage capacity of image data corresponding to the number of pixels (640×480) of the EVF 20.

In an image capture standby state, pixel data of an image captured by the image capturing section 3 every 1/30 second is subjected to predetermined signal processes by the A/D converter 205, black level correcting circuit 206, WB circuit 207, and γ correcting circuit 208, and resultant data is temporarily stored in the image memory 209, transferred to the LCD VRAM 210 and EVF VRAM 220 via the overall control unit 211, and displayed on the LCD 10 and the EVF 20 (live view display).

Consequently, the user can visually recognize an image of the subject. In the playback mode, an image read from the memory card 8 is subjected to a predetermined signal process in the overall control unit 211, and a processed image is transferred to the VRAM 210 and is played back on the LCD 10. An image is similarly displayed on the EVF 20.

A card I/F 212 is an interface used for writing/reading image data to/from the memory card 8. An I/F 224 for communication is an interface conformed with, for example, the USB standard for connecting a personal computer 225 to the outside. A control program recorded on a recording medium such as the memory card 8 or CD-ROM 226 can be loaded to a ROM in the overall control unit 211 via the card I/F 212 and communication I/F 224.

An RTC 219 is a clock circuit for managing date of image capturing and is driven by a separate power supply (not shown).

An operating unit 250 includes various switches, buttons, and the like such as the shutter button 9, LCD button 31, and OK button 32.

The shutter button 9 is a two-level switch of which half-pressed state (S1) and full-pressed state (S2) can be detected, as adopted by a sliver halide camera. When the shutter button 9 is set in the state S1 in the standby mode, the driving of lens for AF is started. While evaluating the contrast of an image in the image memory 209 by the overall control unit 211, the lens is driven and stopped by the motor M2 so as to increase the contrast. By determining the level of image data in the image memory 209 in the state S1, the shutter speed (SS) and the f number are determined. Further, a correction value of the white balance is determined.

The overall control unit 211 takes the form of a microcomputer, and organically controls the driving of the above-described members of the camera to thereby generally control the image capturing operation of the digital camera 1.

FIG. 5 is a block diagram showing an internal function realized by the CPU and memories in the overall control unit 211. The overall control unit 211 has a brightness judgement unit 211a and an exposure amount setting unit 211b for setting exposure control values (shutter speed (SS) and f number).

Further, the overall control unit 211 has a filter unit 211f for performing a filtering process and a recording image generating unit 211g for generating a thumbnail image and a compression image to record the captured image, and has a reproduction image generating unit 211h for generating a reproduction image to reproduce the image recorded in the memory card 8 onto the LCD 10 and the EVF 20.

The filter unit 211f is used to correct the picture quality regarding an outline by correcting high frequency components of an image to be recorded by a digital filter.

The recording image generating unit 211g reads out pixel data from the image memory 209 and generates a thumbnail image and a compression image to be recorded on the memory card 8. The recording image generating unit 211g reads pixel data every eight pixels in each of the lateral and vertical directions from the image memory 209 and sequentially transfers the read pixel data to the memory card 8. In such a manner, while generating a thumbnail image, pixel data is recorded on the memory card 8.

The recording image generating unit 211g reads all of pixel data from the image memory 209 and performs a predetermined compressing process in the JPEG system such as two-dimensional DCT and Huffmann coding to thereby generate image data of a compressed image. The compression image data is stored in the main image area of the memory card 8.

In the image capturing mode, when image capturing is instructed by the shutter button 9, the overall control unit 211 generates a thumbnail image of the image stored in the image memory 209 after the instruction of image capturing and an image compressed in the JPEG system at a set compression ratio. Both images are stored in the memory card 8 together with tag information regarding the captured image (frame number, exposure value, shutter speed, compression ratio, image capturing date, data of on/off of the flash at the time of image capturing, scene information, result of determination of an image, and the like).

In each frame of an image recorded by the digital camera 1, the portion of the tag, high-resolution image data (1600×1200 pixels) compressed in the JPEG system and image data (80×60 pixels) for thumbnail display are recorded.

When the image capturing/playback mode setting switch 14 is set in the playback mode, the image data of the largest frame number in the memory card 8 is read and decompressed by the reproduction image generating unit 211h, and the resultant image data is transferred to the VRAMs 210 and 220, thereby displaying a captured image of the largest frame number, that is, an image most recently captured on the LCD 10 and EVF 20. By operating the button U, an image of a large frame number is displayed. By pressing the button D, an image of a small frame number is displayed.

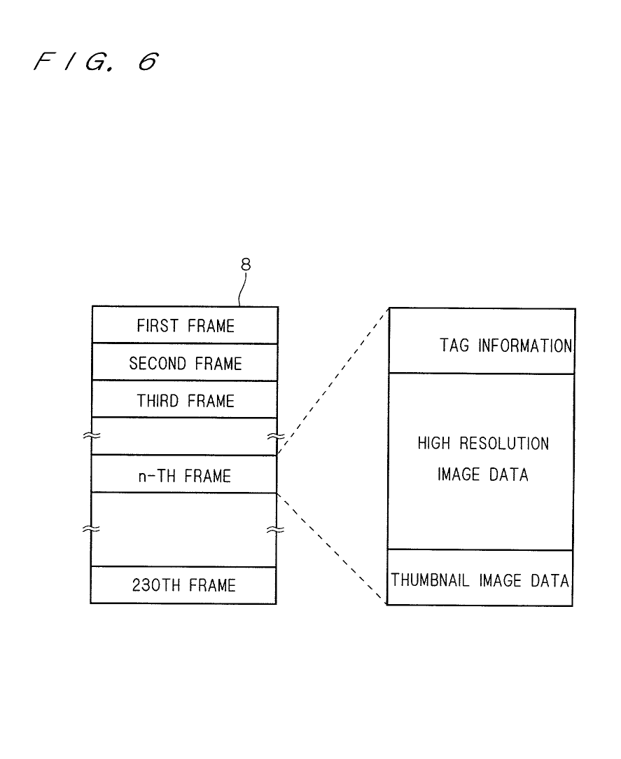

The memory card 8 can, as shown in FIG. 6, store images stored by the digital camera 1 of an amount corresponding to 230 frames at a compression ratio of 1/20. In each frame, the portion of tag information, high-resolution image signals (640×480 pixels) compressed in the JPEG system, and image signals (80×60 pixels) for thumbnail display are recorded. The images can be handled on a frame unit basis as, for example, an image file of the EXIF format.

Referring again to FIG. 5, the overall control unit 211 further includes an environment light detecting unit 211c and a display mode control unit 211d. As will be described hereinlater, the environment light detecting unit 211c performs an operation of detecting various characteristics (brightness and hue) of environment light by using a brightness value (BV) in an automatic exposure adjusting operation (AE operation) and values of various gains at the time of a white balance operation. The display mode control unit 211d also has an image correcting unit 211e. The image correcting unit 211e corrects an image by changing the display characteristics of an image displayed on the LCD 10 and the EVF 20 in accordance with the characteristics of environment light detected by the environment light detecting unit 211c. An image corrected by the image correcting unit 211e is displayed as a live view image on the LCD 10 and the EVF 20 at the time of image capturing. The display mode control unit 211d further includes an environment brightness determining unit 211i and a recommendation display control unit 211j which will be described hereinlater.

A3. Operation in Digital Camera

The operation in the digital camera 1 will now be described. In the following, an operation of optimizing the display characteristics of an image displayed on the electronic view finder (EVF) 20 in accordance with detected environment light will be described. Display characteristics of an image displayed on the EVF 20 are brightness, contrast, and hue in this case. By changing the display characteristics in accordance with the characteristics (brightness, hue, and the like) of environment light, the display characteristics of an image displayed on the EVF 20 are optimized. Such an optimizing operation will be described in, broadly, four cases hereinbelow.

Case 1

First, a case of changing brightness and contrast of an image displayed on the EVF 20 in accordance with brightness of environment light will be described.

In this case, the brightness of environment light can be obtained by using a brightness value BV as an APEX value regarding the brightness of the subject. The APEX value BV regarding the brightness of the subject is derived as a result of automatic exposure adjusting operation (hereinbelow, also called “AE operation”).

The AE operation is performed under the control of the overall control unit 211 (FIG. 4). Specifically, image information stored in the image memory 209 is read by the overall control unit 211 and the brightness of the image is obtained. When the image brightness is lower than a target value in the AE operation, an incident light amount is increased by lowering the shutter speed by the control of the timing generator 314 (and/or opening the aperture by the control of the aperture control driver 306) or the like. When the brightness is higher than the target value, the incident light amount is decreased by a control of, for example, increasing the shutter speed. By repeating such operations, when the brightness of the image enters the range having a predetermined width with respect to the target value in the AE operation, the exposure amount automatic adjusting operation is completed.

The value BV at the time of completion of the automatic adjustment can be obtained as an index value indicative of the brightness of environment light (brightness of the subject). The operation is performed by the environment light detecting unit 211c (FIG. 5).

The brightness value BV has the relation as shown by the following equation 1 with a time value TV as an APEX value regarding shutter speed, an aperture value AV as an APEX value regarding the aperture, and a sensitivity value SV as an APEX value regarding sensitivity.

[Equation 1]

BV=TV+AV−SV

On the basis of Equation 1, by using the values TV, AV, and SV after the automatic exposure adjustment by the AE operation, the value BV can be calculated.

Table 1 shows the relations between the values BV and the environments corresponding to the values BV. The value BV obtained as described above denotes the brightness of environment light in the environment in which the digital camera 1 is used.

TABLE 1

| environment | | IBV |
|---|---|---|
| white clouds | | 12 |
| sea/mountain in fine weather | | 11 |
| fine weather | | 10 |
| sunny weather | | 9 |
| cloudiness | | 8 |
| gloomy cloudiness/shade | | 7 |
| light window side | | 6 |
| stage with spotlight | | 5 |
| human under electric light | | 4 |
| evening scenery | inside well-lighted shop at night | 3 |
| inside house on clear day | amusement park at night | 2 |
| night festival | indoor sports facility | 1 |
| wedding reception | busy streets at night | 0 |

Next, the value BV calculated as an index value indicative of the brightness of environment light is used as a value expressing the brightness of environment light, and the brightness, contrast, and the like of an image displayed on the EVF 20 are adjusted in accordance with the value BV. In such a manner, an operation of adjusting the display characteristics of an image displayed on the EVF 20 in accordance with the value BV is carried out.

An adjusting operation of changing the brightness of an image displayed on the EVF 20 in accordance with the brightness of environment light will be described here. More specifically, a case of lowering the brightness of an image displayed on the EVF 20 as the brightness of environment light becomes higher will be described.

Table 2 shows the relation between the value BV and the brightness of an image displayed on the EVF 20.

TABLE 2

| BV | . . . | 7 | 8 | 9 | 10 | . . . |
|---|---|---|---|---|---|---|
| brightness of | . . . | standard + | standard | standard − | standard −− | . . . |
| EVF | | | | | | |
| contrast of | . . . | standard − | standard | standard + | standard ++ | . . . |
| EVF | | | | | | |

Table 2 shows, as an example, a case of adjusting the brightness of an image displayed on the EVF 20 on the presumption that the brightness of the subject is in a standard state when the value BV is equal to eight. As the value BV increases from eight, the brightness of an image displayed on the EVF 20 is lowered. As the value BV decreases from eight, the brightness of an image displayed on the EVF 20 is increased. The state where the value BV is equal to eight corresponds to brightness of environment light in the case of capturing an image on the outside (cloudy but not gloomy). A case is shown as an example, in which the standard state of the brightness of an image displayed on the EVF 20 is set so that an image on the EVF 20 is seen in the best state with such environment light.

In Table 2, “standard −” in the box (line) of “brightness of EVF 20” denotes a state where the brightness is lowered from the standard state by 10%, and “standard −−” denotes a state where the brightness is lowered from the standard state by 20%. Similarly, “standard +” in the box of “brightness of EVF 20” expresses a state where the brightness is increased from the standard state by 10%, and “standard ++” denotes a state where the brightness is increased by 20% from the standard state.

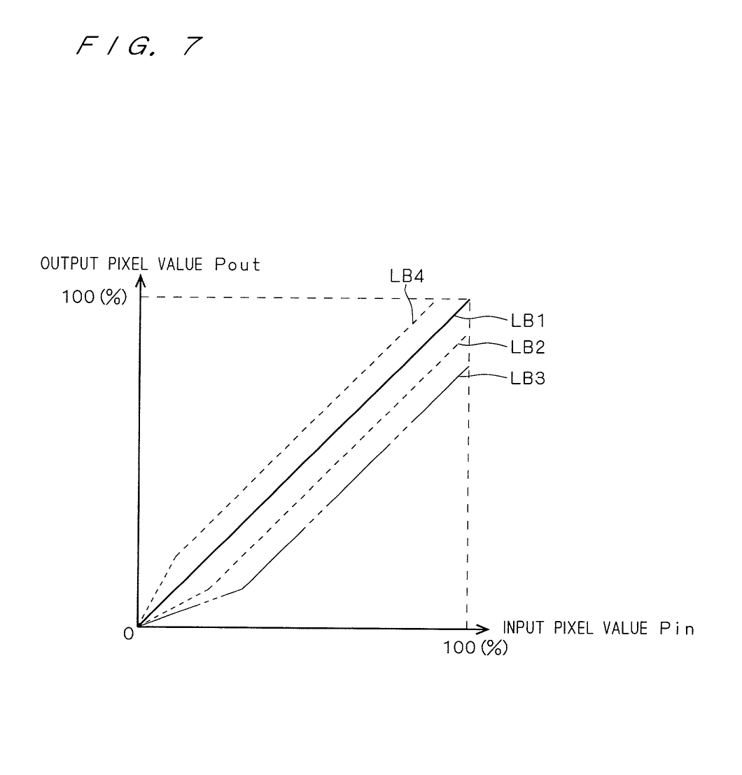

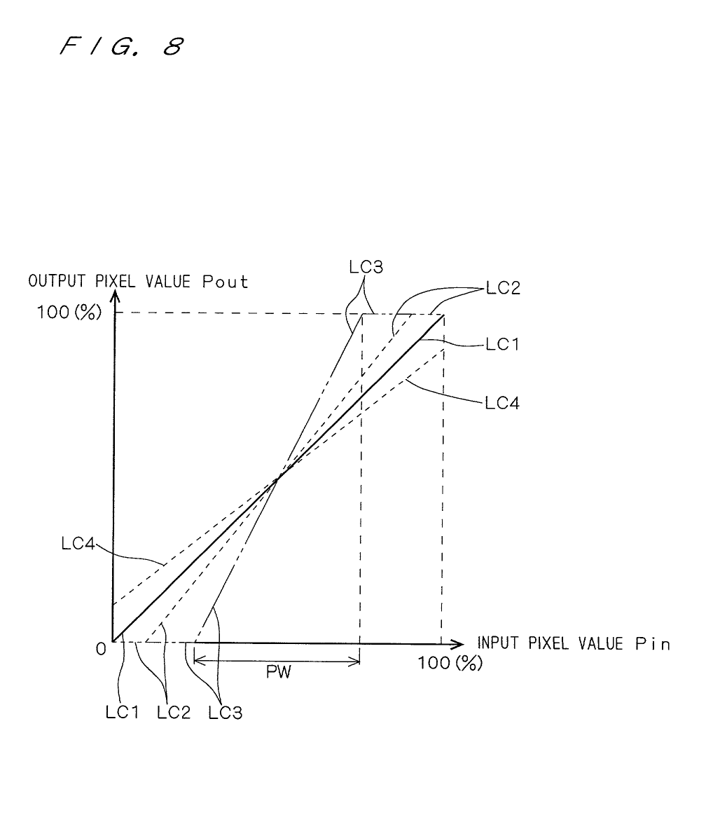

FIG. 7 is a diagram for explaining adjustment of the brightness and shows the relation between an input pixel value Pin and an output pixel value Pout. A line LB1 in FIG. 7 expresses the relation between the pixel values Pin and Pout in the standard state. In the standard state, as shown by the line LB1, the input pixel value Pin and the output pixel value Pout have a linear relation such that their maximum values are the same (and the ratio of the values is one).

As shown in Table 2, when the value BV=9, the display characteristics of an image displayed on the EVF 20 are adjusted so as to decrease the brightness by 10% from the standard state. A line LB2 in FIG. 7 shows the relation between the input pixel values Pin and the output pixel values Pout in the state where the brightness is decreased by 10%. As described above, although the input pixel values Pin are the same, the output pixel value has a state where the brightness is reduced by 10% from the standard state. Similarly, when the value BV=10, the display characteristics of an image displayed on the EVF 20 are adjusted to as to decrease the brightness by 20% from the standard state. A line LB3 in FIG. 7 shows the relation between the input pixel value Pin and the output pixel value Pout in a state where the brightness is decreased by 20%. When the value BV is equal to seven, the display characteristics of an image displayed on the EVF 20 are adjusted so as to increase the brightness by 10% from the standard state. A line LB4 in FIG. 7 shows the relation between the input pixel value Pin and the output pixel value Pout in a state where the brightness is increased by 10%.

It is now assumed that the relation between the input pixel value Pin and the output pixel value Pout with respect to the brightness in each of the states (such as “standard”, “standard +”, and “standard −”) is prestored as a table TBL (FIG. 4) in the ROM in the overall control unit 211.

The image correcting unit 211e (FIG. 5) performs an operation of correcting an output image on the EVF 20 corresponding to the value BV (brightness correcting operation). Specifically, an operation as described hereinbelow is performed.

First, the brightness (any one of “standard”, “standard +”, “standard −”, . . . ) of the EVF 20 according to the brightness (value BV) of environment light obtained in the AE operation is determined. The table TBL corresponding to the determined brightness of the EVF 20 is selected.

Further, by using information stored in the selected table TBL, an output pixel value of each pixel in the EVF 20 is determined. More specifically, by using information in the table TBL determined (selected) in correspondence with the value BV, the pixel value (output pixel value Pout) of the display image on the EVF 20 can be obtained with respect to the pixel value (input pixel value Pin) of each of pixels of a captured image stored in the image memory 209.

In such a manner, the operation of correcting the brightness of the output image on the EVF 20 corresponding to the value BV can be performed.

An adjusting operation of changing the contrast of an image displayed on the EVF 20 in accordance with the brightness of environment light will now be described. Specifically, a case of increasing the contrast of an image displayed on the EVF 20 as the brightness of the environment light increases will be described.

In Table 2, the relation between the value BV and the contrast of an image displayed on the EVF 20 is shown. Table 2 shows the case, as an example, of adjusting the contrast of an image displayed on the EVF 20 on presumption that the brightness of the subject (that is, brightness of environment light) is in the standard state when the value BV is equal to eight. As the value BV increases from eight, the contrast of an image displayed on the EVF 20 is increased. As the value BV decreases from eight, the contrast of an image displayed on the EVF 20 is decreased.

In Table 2, “standard −” in the box of “contrast of EVF 20” denotes a state where the contrast is decreased from the standard state by 10%, and “standard −−” denotes a state where the contrast is decreased from the standard state by 20%. Similarly, “standard +” in the box of “contrast of EVF 20” expresses a state where the contrast is increased from the standard state by 10%, and “standard ++” denotes a state where the contrast is increased by 20% from the standard state.

As shown in Table 2, when the value BV=9, the display characteristics of an image displayed on the EVF 20 are adjusted so as to increase the contrast by 10% from the standard state. When the value BV=10, the display characteristics of an image displayed on the EVF 20 are adjusted to increase the contrast by 20% from the standard state. When the value BV=7, the display characteristics of an image displayed on the EVF 20 are adjusted so as to lower the contrast by 10% from the standard state.

FIG. 8 is a diagram showing the relation between an input pixel value Pin and an output pixel value Pout. A line LC1 in FIG. 8 expresses the relation between the pixel values Pin and Pout in the standard state. In the standard state, as shown by the line LC1, the input pixel value Pin and the output pixel value Pout have a linear relation such that their maximum values are the same.

A line LC2 in FIG. 8 shows the relation between the input pixel value Pin and the output pixel value Pout in the state where the contrast is increased by 20%. A line LC3 in FIG. 8 shows the relation between the input pixel value Pin and the output pixel value Pout in a state where the contrast is increased by 50%.

As described above, the relation between the input pixel value Pin and the output pixel value Pout is determined so that an intermediate zone having a predetermined width PW of the input pixel value Pin covers the full range of the output pixel value Pout. Consequently, the contrast of an image can be increased. For example, by making the intermediate zone having the width PW which is reduced with respect to the full range of the input pixel value Pin by 50% correspond to the full range of the output pixel value Pout, the contrast can be increased from the standard state by 50%.

A line LC4 in FIG. 8 shows the relation between the input and output pixel values in a state where the contrast is decreased by 20%. By determining the relation between the input pixel value Pin and the output pixel value Pout in such a manner, the contrast can be lowered from the standard state by 20%.

It is assumed that the relation between the input pixel value Pin and the output pixel value Pout with respect to the contrast in each of the states (such as “standard”, “standard +”, and “standard −”) is prestored as a table TBL (FIG. 4) in the ROM in the overall control unit 211. By preparing a table TBL indicative of the adjustment states of contrast with respect to adjustment states of brightness, the brightness and contrast can be simultaneously adjusted.

The image correcting unit 211e (FIG. 5) performs an operation of correcting an output image on the EVF 20 corresponding to the value BV (contrast correcting operation) on the basis of the relation as shown in Table 2. Specifically, an operation as described hereinbelow is performed.

First, the contrast (any one of “standard”, “standard +”, “standard −”, . . . ) of an image displayed on the EVF 20 according to the brightness (value BV) of environment light obtained in the AE operation is determined. The table TBL corresponding to the determined contrast of an image displayed on the EVF 20 is selected.

Further, by using information stored in the selected table TBL, an output pixel value of each pixel in the EVF 20 is determined. More specifically, by using information in the table TBL determined (selected) in correspondence with the value BV, the pixel value (output pixel value Pout) of the image displayed on the EVF 20 can be obtained with respect to the pixel value (input pixel value Pin) of each of pixels of a captured image stored in the image memory 209.

In such a manner, the operation of correcting the contrast of the output image on the EVF 20 corresponding to the value BV can be performed.

In the case of performing the adjustment of the contrast of an image displayed on the EVF 20 as described above, the contrast of the image displayed on the EVF 20 is adjusted so as to increase as the brightness of environment light becomes higher. Consequently, even when the condition of the ambient light of the digital camera 1 is high (brightness of the environment light is high), an easy-to-see image can be displayed on the EVF 20.

In the case of performing only the contrast adjustment for increasing the contrast, depending on the subject, the user may feel that an image on the display 20 is glaring. Such a situation can be prevented by performing the adjustment of brightness as described above on the EVF 20 in addition to the adjustment of the contrast. That is, by reducing the brightness and increasing the contrast of an image displayed on the EVF 20 as the brightness of environment light increases, an easy-to-see image can be displayed while suppressing glare.

Case 2

Another adjusting operation of changing the brightness of an image displayed on the EVF 20 in accordance with the brightness of environment light will now be described. The operation is performed in a manner opposite to that of the case 1. Specifically, as the brightness of environment light increases, the brightness of an image displayed on the EVF 20 is also increased. In other words, as the brightness of environment light decreases, the brightness of an image displayed on the EVF 20 is also reduced.

Table 3 shows the relation between the value BV and the brightness of an image displayed on the EVF 20.

TABLE 3

| BV | . . . | 7 | 8 | 9 | 10 | . . . |
|---|---|---|---|---|---|---|
| brightness of | . . . | standard − | standard | standard + | standard ++ | . . . |
| EVF | | | | | | |

Table 3 shows, as an example, a case of adjusting the brightness of an image displayed on the EVF 20 on the presumption that the brightness of the subject is in a standard state when the value BV is equal to eight. As the value BV increases from the value in the standard state, the brightness of an image displayed on the EVF 20 is increased. As the value BV decreases from the value in the standard state, the brightness of an image displayed on the EVF 20 is decreased. In Table 3, “standard −”, “standard −−”, “standard +”, “standard ++”, and the like denote the states in a manner similar to Table 2.

In the adjusting operation, as shown in Table 3, when the value BV=9, the display characteristics of an image displayed on the EVF 20 are adjusted so as to increase the brightness by 10% from the standard state. When the value BV=10, the display characteristics of an image displayed on the EVF 20 are adjusted so as to increase the brightness by 20% from the standard state. When the value BV=7, the display characteristics of an image displayed on the EVF 20 are adjusted so as to reduce the brightness by 10% from the standard state.

Specifically, as described above, the relations between the input pixel value Pin and the output pixel value Pout with respect to the brightness in the states (such as “standard”, “standard +”, and “standard −”) are prestored as a table TBL in the ROM in the overall control unit 211. The brightness (display characteristic) of an image displayed on the EVF 20 is determined in accordance with the brightness of environment light. By using the information stored in the table TBL, which corresponds to the determined brightness, an output pixel value of each pixel in the EVF 20 is determined.

When such adjustment of the brightness of an image displayed on the EVF 20 is performed, as the brightness of environment light increases, the brightness of an image displayed on the EVF 20 is adjusted so as to be increased. Consequently, for example, in the case where the user monitors the real subject with his/her right eye and sees an image on the finder (live view image on the EVF 20) his/her left eye, it can be prevented that the brightness difference makes the user feels strange. When the brightness of ambient light is high, an image on the EVF 20 has high brightness, so that the image can be easily seen. On the contrary, when the brightness of ambient light is low, an image on the EVF 20 also has low brightness, so that the image can be easily seen. When a light shielding member such as the eyepiece cap 23 (shown by a broken line in FIG. 2) is provided between the eye of the user and the ocular 21 (FIG. 2) of the EVF 20, such an increased effect is produced.

Case 3

The case of changing the display characteristics of an image displayed on the EVF 20 in accordance with the brightness of environment light has been described above. In the following, the case of changing the hue of an image displayed on the EVF 20 in accordance with the hue of environment light will be described.

First, a case of adjusting the hue of an image displayed on the EVF 20 so that the hue of environment light and that of an image displayed on the EVF 20 are set in the opposite directions will be described.

The hue of environment light is reflected in the result of a white balance adjusting operation by the WB circuit 207. The CCD 303 independently controls gains GR, GG, and GB regarding pixels of three primary colors of red (R), green (G), and blue (B), respectively, thereby controlling the white balance. An image subjected to adjustment of white balance is stored in the image memory 209 (FIG. 4).

Generally, the white balance is controlled by increasing or decreasing the gains GR and GB relative to the gain GG regarding green (G). For example, as a standard state, the gain (R gain) GR of red (R) is set to be 1.8 times as high as the gain GG of green (G), and the gain (B gain) GB of blue (B) is set to be 2.0 times as high as the gain GG. By changing the relative relations of the gains in the standard state, the white balance, that is, hue can be changed. In this case, the gains GR, GG, and GB are used to express the ratio of the input pixel value of each pixel to the output pixel value. For example, when the G gain GG regarding green (G) is set as “1.0”, in the standard state, the R gain GR regarding red (R) is “1.8” and the B gain GB regarding blue is “2.0”.

In the operation of adjusting white balance, when blueness in the hue of environment light is strong, by increasing the R gain GR and decreasing the B gain GB, the hue of an image captured is controlled. By the control, a captured image stored in the image memory 209 has proper hue. For example, the operation of controlling white balance is performed so that a captured image has proper hue by measuring color temperature of an entire image, in accordance with the measured color temperature, increasing the R gain GR to “2.2”, and decreasing the B gain GB to “1.6”. In this case, by reading the values of the gains GR, GG, and GB in the white balance control operation, the hue of environment light (state where blueness is strong in the above case) can be known.

In the embodiment, the operation of adjusting the hue of an image displayed on the EVF 20 is performed so that the image has the characteristic opposite to the hue of environment obtained as described above.

Table 4 shows the relation between the R gain as an index value regarding the hue of environment light and a redness control value of the EVF 20 as an index value regarding the hue of an image displayed on the EVF 20.

TABLE 4

| R gain | . . . | 1.2 | 1.4 | 1.8 | 2.2 | . . . |
|---|---|---|---|---|---|---|
| redness control | . . . | standard −− | standard − | standard | standard + | . . . |
| of EVF | | | | | | |

Similarly, Table 5 shows the relation between the B gain as an index value regarding the hue of environment light and a blueness control value of the EVF 20 as an index value regarding the hue of an image displayed on the EVF 20.

TABLE 5

| B gain | . . . | 1.4 | 1.6 | 2.0 | 2.4 | . . . |
|---|---|---|---|---|---|---|
| blueness | . . . | standard −− | standard − | standard | standard + | . . . |
| control of EVF | | | | | | |

In Table 4 (Table 5), “standard −” denotes a state where a redness (blueness) control value is decreased from the standard state by 10%, and “standard −−” denotes a state where the redness (blueness) control value is decreased from the standard state by 20%. Similarly, “standard +” denotes a state where the redness (blueness) control value is increased from the standard state by 10%.

Tables 4 and 5 shows, an example, the case where the hue of an image displayed on the EVF 20 is adjusted on assumption that the hue of environment light is in the standard state when the R gain GR=1.8 and the B gain GB=2.0. As shown in Table 4, the redness control value of the EVF 20 is increased as the R gain GR increases from the value in the standard state, and the redness control value of the EVF 20 is decreased as the R gain GR decreases from the value in the standard state. Similarly, as shown in Table 5, the blueness control value of the EVF 20 is decreased as the B gain GB decreases from the value in the standard state, and the blueness control value of the EVF 20 is increased as the B gain GB increases from the value in the standard state.

In the case where the color temperature is high (for example, 8000K) and the environment light is bluish, for example, the WB circuit 207 increases the R gain GR to “2.2” and decreases the B gain GB to “1.6”, thereby adjusting the hue to be proper. In other words, by detecting that the R gain GR is increased to “2.2” and the B gain GB is decreased to “1.6”, the state where the environment light is very bluish can be recognized.

In order to deal with the situation, the overall control unit 211 performs a control so that the redness control value of EVF is increased by 10% as shown in Table 4 and the blueness control value of EVF is decreased by 10%. By the control, the hue of an image displayed on the EVF 20 is changed so that an image having strong redness and weak blueness is displayed on the EVF 20. That is, the operation of adjusting the hue of an image displayed on the EVF 20 is performed so as to have the characteristic opposite to that of the hue of the environment light.

To increase or decrease the control value for each color of the EVF 20, it is sufficient to perform the above-described brightness value adjusting operation for each color. For example, to increase the redness control value of EVF by 10%, it is sufficient to increase the brightness of the red color component in each pixel by 10% by the above-described brightness value adjusting operation. To decrease the blueness control value of EVF by 10%, it is sufficient to decrease the brightness of the blue color component in each pixel by the above-described brightness value adjusting operation.

More specifically, the hue adjusting operation is carried out as follows. In this case, it is assumed that, prior to the adjusting operation, a plurality of tables TBL regarding the brightness and the like are prepared for each color, and another table TBL of information regarding the control for each color shown in Tables 4 and 5 are prepared in the overall control unit 211.

First, information regarding the control value of each color according to the hue of environment light is obtained by using the table TBL having the information of Tables 4 and 5, and the table TBL for each color regarding brightness or the like, which corresponds to the control value, is selected. The operation of adjusting the hue of an image displayed on the EVF 20 is performed by deriving the output pixel value Pout of each of pixels of the EVF 20 on the basis of the relation between the input pixel value Pin and the output pixel value Pout stored in the selected table TBL for each color. The input pixel value Pin is a pixel value stored in the image memory 209, and the output pixel value Pout at the time of outputting an image to the EVF 20 is obtained on the basis of the input pixel value Pin by using the table TBL.

By transferring such an output pixel value Pout to the VRAM 220, a captured image according to the output pixel value can be displayed on the EVF 20.

In this case, the image correcting unit 211e adjusts the hue of an image displayed on the EVF 20 so as to be changed in the direction opposite to the hue of the environment light. Thus, an influence of the hue of stray light entering the ocular 21 (FIG. 2) of the EVF 20 can be cancelled out (reduced). For example, when the hue of environment light is very bluish, the hue of an image displayed on the EVF 20 is adjusted to have weak blueness by the above adjusting operation. Thus, the influence of stray light having strong blueness entering the EVF 20 can be cancelled out (reduced).

Case 4

In the above, the case of changing the hue of an image displayed on the EVF 20 in accordance with the hue of environment light by adjusting the hue of an image displayed on the EVF 20 in the direction opposite to that of environment light has been described. A case of adjusting the hue of an image displayed on the EVF 20 in the same direction as that of the hue of environment light will now be described.

Table 6 shows the relation between the R gain as an index value regarding the hue of environment light and a redness control value of the EVF 20 as an index value regarding the hue of an image displayed on the EVF 20.

TABLE 6

| R gain | . . . | 1.2 | 1.4 | 1.8 | 2.2 | . . . |
|---|---|---|---|---|---|---|
| redness control | . . . | standard ++ | standard + | standard | standard − | . . . |
| of EVF | | | | | | |

Similarly, Table 7 shows the relation between the B gain as an index value regarding the hue of environment light and a blueness control value of the EVF 20 as an index value regarding the hue of an image displayed on the EVF 20.

TABLE 7

| B gain | . . . | 1.4 | 1.6 | 2.0 | 2.4 | . . . |
|---|---|---|---|---|---|---|
| blueness | . . . | standard ++ | standard + | standard | standard − | . . . |
| control of EVF | | | | | | |

In Table 6 (Table 7), “standard −” denotes a state where a redness (blueness) control value is decreased from the standard state by 10%, and “standard +” denotes a state where the redness (blueness) control value is increased from the standard state by 10%. Similarly, “standard ++” denotes a state where the redness (blueness) control value is increased from the standard state by 20%.

Tables 6 and 7 show, an example, the case where the hue of an image displayed on the EVF 20 is adjusted on assumption that the hue of environment light is in the standard state when the R gain GR=1.8 and the B gain GB=2.0. As shown in Table 6, the redness control value of the EVF 20 is decreased as the R gain GR increases from the value in the standard state, and the redness control value of the EVF 20 is increased as the R gain GR is decreased from the value in the standard state. Similarly, as shown in Table 7, the blueness control value of the EVF 20 is increased as the B gain GB decreases from the value in the standard state, and the blueness control value of the EVF 20 is decreased as the B gain GB is increased from the value in the standard state.

In the case where the color temperature is high (for example, 8000K) and the environment light is bluish, for example, the WB circuit 207 increases the R gain GR to “2.2” and decreases the B gain GB to “1.6”, thereby adjusting the hue to be proper. In other words, by detecting that the R gain GR is increased to “2.2” and the B gain GB is decreased to “1.6”, the state where the environment light is very bluish can be recognized.

In order to deal with the situation, the overall control unit 211 performs a control so that the redness control value of EVF is decreased by 10% as shown in Table 6 and the blueness control value of EVF is increased by 10% as shown in Table 7. By the control, the hue of an image displayed on the EVF 20 is changed so that a bluish image is displayed on the EVF 20. That is, the operation of adjusting the hue of an image displayed on the EVF 20 is performed so as to have the characteristic of same direction to that of the hue of the environment light.

The specific adjusting operation is similar to that in the case 3 but is different from the case 4 with respect to the point that the hue of an image displayed on the EVF 20 is adjusted in the same direction as that of the hue of environment light on the basis of the relations shown in Tables 6 and 7 as an example.

In this case, the image correcting unit 211e adjusts the hue of an image displayed on the EVF 20 so as to change in the same direction as that of environment light (when the environment light has the bluish hue, adjustment is made so that an image having bluish hue is displayed on the EVF 20). Consequently, an image displayed on the EVF 20 becomes close to an image of the subject seen by the naked eyes. When an influence of stray light is eliminated, for example, when a light shielding member such as the eyepiece cap 23 (refer to FIG. 2) is provided between the eye of the user and the ocular 21 of the EVF 20, a larger effect is produced.

B. Second Preferred Embodiment

A second embodiment relates to a case where the display state (on/off or the like) in two kinds of displays (in this case, the LCD 10 and EVF 20) is changed according to the brightness of environment light.

The configuration and the like of a digital camera according to the second embodiment is similar to that of the first embodiment, and different points from the first embodiment will be mainly described hereinbelow.

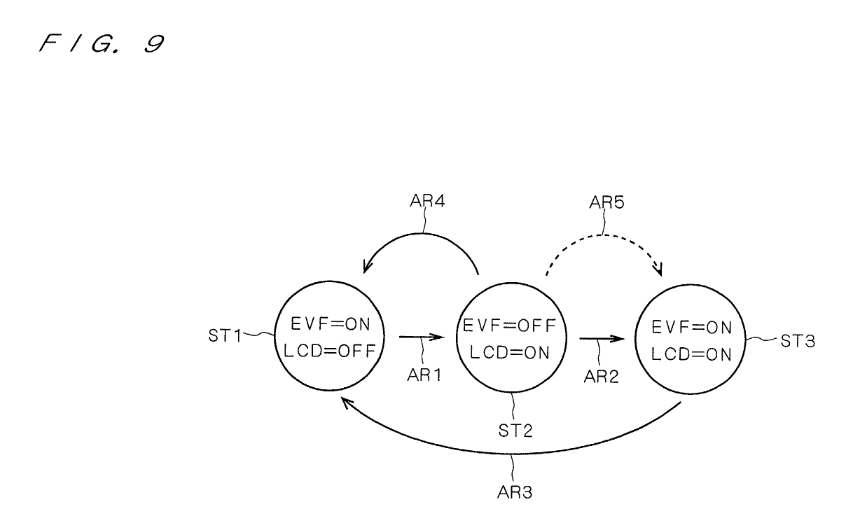

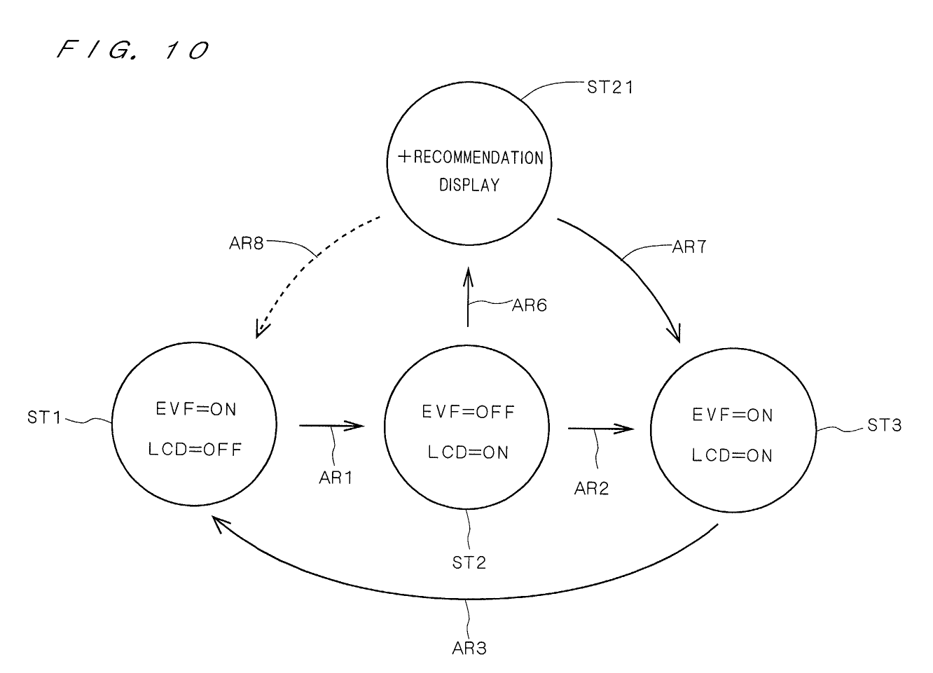

FIG. 9 is a state switching diagram regarding the display states of the LCD 10 and EVF 20. As described above, the display states of the LCD 10 and EVF 20 are changed by the depression of the LCD button 31 (refer to FIG. 3). More specifically, each time the LCD button 31 is depressed, the display states of the LCD 10 and EVF 20 are switched like the states ST1, ST2, ST3, ST1, . . . (refer to the arrows AR1, AR2, and AR3). An image such as live view image is displayed on an ON-state one of the two kinds of displays (LCD 10 and EVF 20). Display of the live view image will be described hereinbelow. The state ST1 is a state where the EVF 20 is ON and the LCD 10 is OFF. The state ST2 is a state where the EVF 20 is OFF and the LCD 10 is ON. The state ST3 is a state where both of the EVF 20 and the LCD 10 are ON.

Since a case where at least one of the LCD 10 and the EVF 20 is ON in a state where the power source of the digital camera 1 is ON is assumed here, a state where both of the EVF 20 and the LCD 10 are in the OFF state is not considered. Such a state can be also included in the above states.

The display states of the LCD 10 and the EVF 20 may be changed not only by manually with the LCD button 31 but also automatically in accordance with environment light. More specifically, according to the “brightness” of environment light, the state is automatically switched to a state where at least the EVF 20 out of the LCD 10 and the EVF 20 is ON, in other words, the state (state ST1 or ST3) where a captured image is displayed at least on the EVF 20.

For example, in the state ST2 where only the LCD 10 is ON, when the brightness of environment light is high, the user may feel that a display screen on the LCD 10 is not clearly seen (visibility is low). This is due to an influence of reflection of the environment light having high brightness on the surface of the LCD 10, for example, in the case where a transmission-type liquid crystal is used for the LCD 10.

In contrast, in the digital camera 1 of the embodiment, to eliminate such a detrimental effect, the display states of the LCD 10 and the EVF 20 are changed according to the brightness of environment light.

As described in the foregoing first embodiment, the brightness of environment light can be obtained by using the value BV as the APEX value regarding the brightness of the subject. By using the value BV and using the reference that the brightness of environment light is high when the value BV is higher than a predetermined value (for example, nine or higher, which is the value higher than eight), whether the brightness of environment light is high or not can be determined. The determining operation is carried out by the environment brightness determining unit 211i (FIG. 5) in the overall control unit 211.

When the brightness of the environment light is determined to be high on the basis of such a reference, the state is changed to the state ST1 where the EVF 20 is turned on as shown by the arrow AR4 (FIG. 9). In this case, the EVF 20 is not so influenced by the environment light as compared with the LCD 10. Consequently, even when the brightness of environment light is high, the EVF 20 can assure relatively high visibility.

When the brightness of environment light is determined to be high on the basis of the reference, the state may be changed to the state ST3 where both the EVF 20 and the LCD 10 are ON as shown by the arrow AR5. In this case as well, since the EVF 20 is turned on, a captured image is displayed at least on the EVF 20. Even when the brightness of the environment light is high, the operator (or user) can therefore recognize the captured image in the live view display mode on the EVF 20, and relatively high visibility can be assured (displaying of easy-to-see image can be assured).

Any of the state switching indicated by the arrows AR4 and AR5 may be carried out. Alternately, it is also possible to set the state switching AR4 or AR5 as a default, and arbitrarily select one of the state switching AR4 or AR5 by the operator on a menu screen or the like. The state switching operation (in other words, the operation of changing the display state) is realized by the display mode control unit 211d in the overall control unit 211.

According to the digital camera 1 of the embodiment, the display state of at least one of the LCD 10 and the EVF 20 is changed according to the environment light. Consequently, the LCD 10 and EVF 20 can be switched to the appropriate display state according to the using condition (brightness of environment light). That is, the display state of each of the LCD 10 and EVF 20 can be optimized, and the operability can be improved.

Modification of Second Preferred Embodiment

The case of automatically switching the state to the state (ST1 or ST3) in which a captured image is displayed at least on the EVF 20 when the brightness of environment light is determined to be high has been described above. Indication of recommending to switch the state to the state where a captured image is displayed at least on the EVF 20 may be given on the LCD 10. When the operator sees such indication, he/she can switch the display states of the LCD 10 and EVF 20 by a manual operation of the LCD button 31.

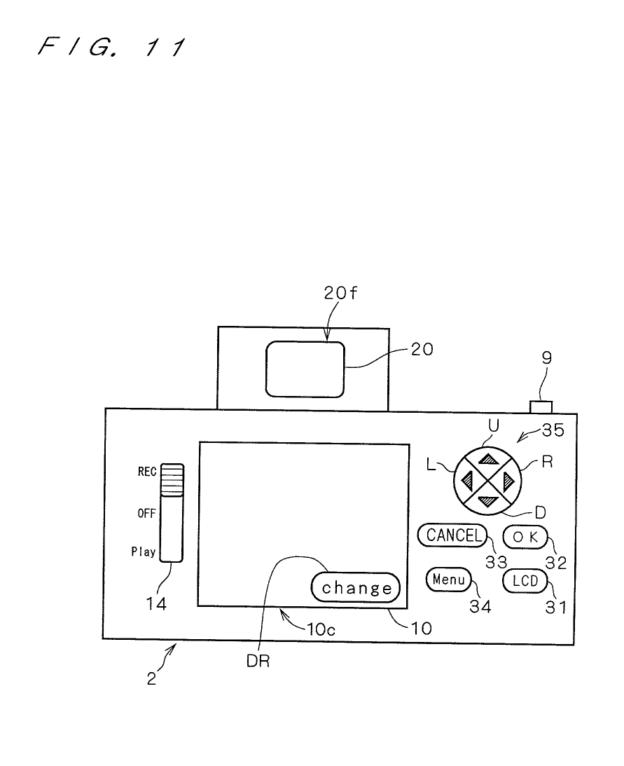

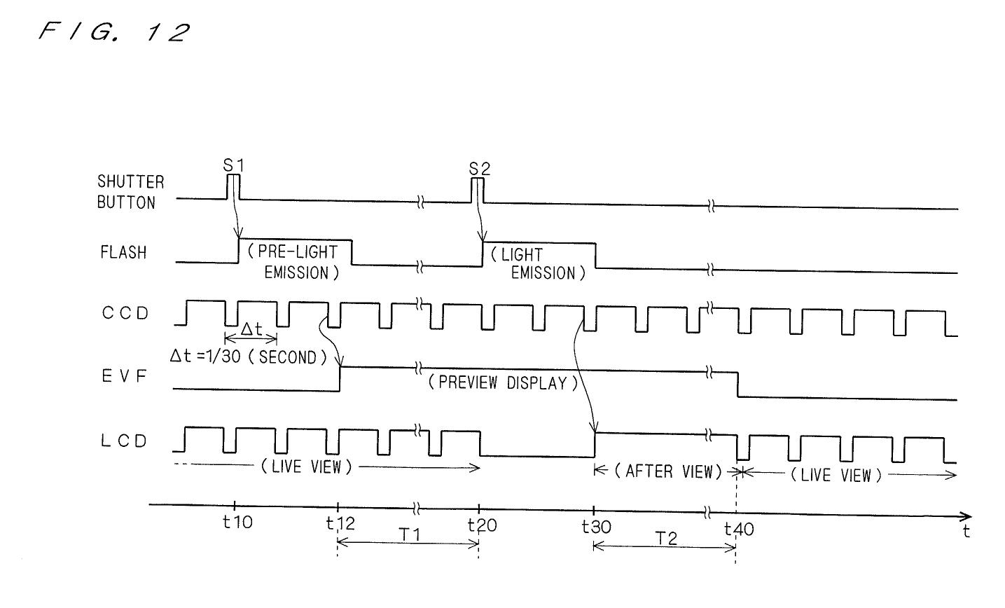

FIG. 10 is a diagram showing the switching of the display states of the LCD 10 and EVF 20 as a modification. In addition to the states ST1, ST2, and ST3, a state ST21 is shown in FIG. 10. In the state ST21, indication of recommendation (or indication of suggestion) DR (refer to FIG. 11) to switch the state ST2 where the EVF 20 is OFF and the LCD 10 is ON to a state (ST1 or ST3) where at least the EVF 20 is ON is given on the LCD 10.

For example, when it is determined that the brightness of environment light is high in the state ST2 where only the LCD 10 is ON, as shown by the arrow AR6 (FIG. 10), the state ST2 is switched to the state ST21. Whether the brightness of environment light is high or not may be determined by using a reference such that the brightness of environment light is high when the value BV is nine or higher.

When it is determined that the brightness of environment light is high, the indication DR for recommending the switch to a state (ST1 or ST3) where at least the EVF 20 out of the LCD 10 and EVF 20 is ON, in other words, a state where a captured image is displayed at least on the EVF 20 (state ST1 or ST3) is made.

FIG. 11 shows a state where the recommendation indication DR (or suggestion) is given on the LCD 10. FIG. 11 shows a case where a message “change” is indicated as the indication DR to change the display states of the LCD 10 and EVF 20. The indication DR is not limited to the message. Other message or other display method of, for instance, flickering the entire screen of the LCD 10 may be used. Such indication is realized by the recommendation display control unit 211j (FIG. 5) in the overall control unit 211.

The operator who sees the indication DR on the LCD 10 can switch the display state of the LCD 10 and EVF 20 to the state ST3 as shown by the arrow AR7 by manual operation of the LCD button 31. By the operation, in addition to the LCD 10, the EVF 20 is also turned on, and a captured image is displayed on the EVF 20. Consequently, the operator can check the captured image by live view display on the EVF 20, and relatively high visibility can be assured.

When the operator judges that it is unnecessary to display an image on the LCD 10, the LCD button 31 is pressed again to switch the display state of the LCD 10 and EVF 20 to the state ST1. The state ST1 denotes a state where the LCD 10 is OFF but the EVF 20 is ON. In this case, by displaying an image on the EVF 20, a similar effect can be obtained. Further, by not displaying an image on the LCD 10, an effect such as reduction in power consumption can be produced.

By giving the indication DR, information regarding a proper display state can be provided to the operator. The operator can therefore recognize the state where the brightness of environment light is high and display on the EVF 20 is preferable, and switch the state of the LCD 10 and EVF 20 to the proper one according to the environment (brightness of environment light). That is, the display state of the LCD 10 and EVF 20 can be optimized, and the easy operability can be improved.

Although the case of switching the state ST21 to the state ST3 as shown by the arrow AR7 has been described above, the state may be switched from the state ST21 to the state ST1 as shown by the arrow AR8.

C. Third Preferred Embodiment

In a third embodiment, a case of selectively using the display states in two kinds of displays (the LCD 10 and EVF 20 in this case) in accordance with the using condition such that an image is captured with a flash in a dark environment will now be described.

The configuration and the like of the digital camera is similar to that of the first embodiment and different points will be mainly described hereinbelow.

First, the overall control unit 211 determines whether an image is to be captured with a flash or not. For example, in a case of giving an instruction of capturing an image with a flash by a predetermined operation of the operator, or in a case of determining whether an image is automatically captured with a flash or not by detecting the brightness of environment light, a state where an image is to be captured with a flash can be determined. In the following, an operation after determining that an image is to be captured with a flash will be described.

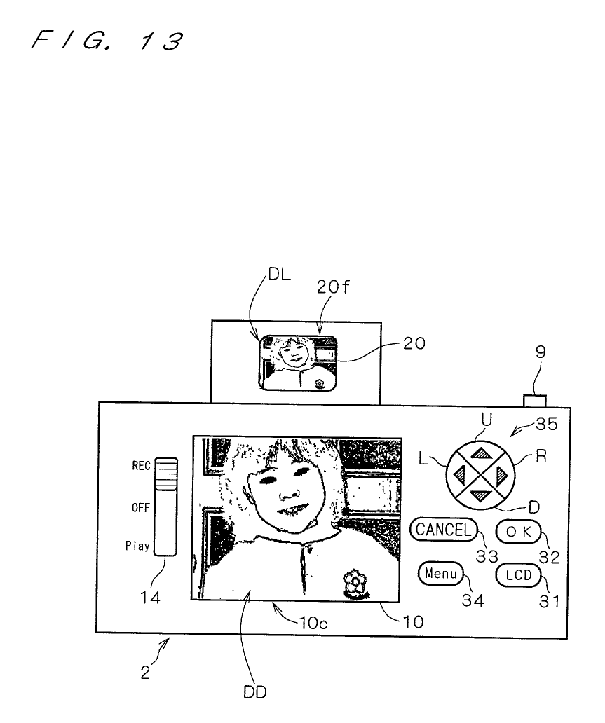

FIG. 12 is a timing chart showing a display state of the LCD 10 and EVF 20 in the period before and after the shutter button 9 (FIG. 3) is pressed. In the following, by referring to FIG. 12, operations in the LCD 10, EVF 20, and the like will be described. The operation of changing the display state in the LCD 10 and EVF 20 is performed by using the display mode control unit 211d (FIG. 5).

It is assumed now that, first, in an image capture standby state, an image of the subject is captured every 1/30 (second) by the CCD 303 (FIG. 4), and images are outputted via the image memory 209 and the like to the LCD 10, thereby performing live view display. At this time, an image is not displayed on the EVF 20.

In response to a pulse signal generated when the operator presses the shutter button 9 to the half-pressed state (S1) at time t10, the flash 5 performs pre-light emission. A still image (also called a pre-light emission image) of the subject irradiated with flash light by the pre-light emission is obtained by the CCD 303. The pre-light emission image is displayed on the EVF 20 for at least a predetermined period T1 after time tl2 (preview display). FIG. 12 shows the case where the preview display on the EVF 20 is made until the end (time t40) of after-view display on the LCD 10 after flash which will be described hereinlater. After that, in response to a pulse signal generated when the operator presses the shutter button 9 to the full-pressed state (S2) at time t20, the flash 5 flashes normally. Further, a still image (also called a flash image) of the subject irradiated with flash light is obtained by the CCD 303. The flash image is displayed on the LCD 10 for a predetermined period T2 after time t30 (after-view display). By the after-view display, the operator can check the captured still image. After elapse of the period T2 (after time t40), the LCD 10 performs again the live view display.

FIG. 13 is a diagram showing the display state of the LCD 10 and EVF 20 in the period T1. As shown in FIG. 13, the pre-light emission image DL captured with flash light is displayed on the EVF 20, and a live view image DD in a dark environment without flash light is displayed on the LCD 10.

As described above, in the period T1 before capturing an image with flash, while displaying the live view image on the LCD 10, a pre-light emission image is displayed on the EVF 20. Consequently, by comparing both displays (live view display on the LCD 10 and preview display on the EVF 20) with each other, the operator can easily imagine a finished image. As described above, the display states on the LCD 10 and EVF 20 at the time of capturing an image with a flash such as image capturing at night are optimized, thereby enabling the easy operability to be improved.

Particularly, since a pre-light emission image is displayed on the EVF 20 capable of assuring relatively high visibility in a dark environment, it becomes easy to check an image to be captured (finished image) by using the EVF 20. Therefore, framing can be easily made also in a dark environment.

D. Fourth Preferred Embodiment

In a fourth embodiment, a case of properly using a display state in two kinds of displays (the LCD 10 and the EVF 20) at the time of capturing an image in a dark environment (irrespective of whether a flash is used or not) will be described. More specifically, under circumstances such that the brightness of the subject is low and framing is difficult, live view display is carried out in a state where the brightness of an image displayed on the LCD 10 and that of an image displayed on the EVF 20 are set to be different from each other.

The configuration and the like of the digital camera is similar to that of the first embodiment and different points will be mainly described hereinbelow.

First, the overall control unit 211 determines whether the brightness of the subject is low or not on the basis of a predetermined reference. As the predetermined reference, for example, when the value BV becomes equal to or lower than a predetermined value (for example, BV=3), it is determined that the brightness of the subject is low (in other words, the brightness of environment light is low).

By using a gain G1 for the LCD 10 in the case where the brightness of environment light is determined to be low (that is, dark), an image having brightness (normal brightness) similar to that of a captured image is displayed as a live view. By using a gain G2 higher than the gain G1 for the EVF 20, an image having high brightness (light image) is displayed as a live view.

The “gain” denotes here, as described above, a ratio (that is, Pout/Ppin) between the input pixel value Pin and the output pixel value Pout. For example, the gain G1 is a ratio between the pixel value (input pixel value Pin) of a captured image stored in the image memory 209 and the pixel value (output pixel value Pout) of a display image on the LCD 10 regarding a predetermined pixel. By multiplying the pixel value (input pixel value Pin) of each pixel stored in the image memory 209 by the gain G1 corresponding to the pixel value, the output pixel value Pout of each pixel at the time of outputting an image onto the LCD 10 can be calculated.

Similarly, the gain G2 is a ratio between the pixel value (input pixel value Pin) of a predetermined pixel stored in the image memory 209 and the pixel value (output pixel value Pout) of an image on the EVF 20. By multiplying the pixel value (input pixel value Pin) of each pixel stored in the image memory 209 by the gain G2 corresponding to the pixel value, the output pixel value Pout of each pixel at the time of outputting an image onto the EVF 20 can be calculated.

The respective values of the gains G1 and G2 are not always necessarily equal to each input pixel value Pin. Each of the gains G1 and G2 may be determined for each input pixel value Pin. The relation between the input pixel value Pin and the output pixel value Pout can be stored in the table TBL in the overall control unit 211 as described above. An operation of correcting output images on the LCD 10 and EVF 20 using the gains G1 and G2 is carried out by the image correcting unit 211e (FIG. 5).

A case of using a value obtained by multiplying the gain G1 by a predetermined value (for example, 1.2) larger than 1 as the gain G2 regarding display of the EVF 20, as shown by Equation 2 will be described.

[Equation 2]

G2=1.2×G1

By performing image display using the gain G2 (>G1) larger than the gain G1 (that is, image display with the increased gain) on the EVF 20, the EVF 20 displays an image (light image) having brightness higher than the LCD 10 as a live view.

Also under circumstances that the brightness of the subject is low and framing is difficult, by using the gain GI similar to that of a captured image, an image having normal brightness is displayed on the LCD 10 as a live view, and an image having brightness higher than that of the LCD 10 (that is, easy-to-see image) is displayed as a live view on the EVF 20. By the operation, the operator can easily perform framing by using the live view display on the EVF 20 on which an image (light image) having higher brightness is displayed while presuming an exposure state of a captured image from live-view display of the LCD 10. That is, a framing operation in which the exposure state is considered can be easily realized also in a dark environment.

Although the case of displaying an image with a increased gain (G2>G1) on the EVF20 has been described above, an image may be displayed on the EVF 20 with a decreased gain (G2<G1).

More specifically, in the case where it is determined that the brightness of environment light is high (that is, bright), an image having normal brightness is displayed as a live view on the LCD 10 by using the gain G1 similar to that of an image to be captured, and an image having low brightness (dark image) is displayed on the EVF 20 as a live view by using the gain G2 lower than the gain G1. As the gain G2, as shown by Equation 3, a value obtained by multiplying the gain G1 by a predetermined value (for example, 0.8) smaller than 1 is used.

[Equation 3]

G2=0.8×G1

By the operations, an image having brightness lower than that of the LCD 10 (darker image) is displayed as a live view on the EVF 20. Even under the circumstances that the brightness of environment light is high, an image with suppressed brightness (image with suppressed glare) is displayed on the EVF 20. Thus, an easy-to-see image can be displayed.

E. Others

In each of the foregoing embodiments, in Table 2 and the like, for example, “standard +” denotes a state where the display characteristic such as brightness is increased from the standard state by 10%. However, the invention is not limited to the numerical value. For example, “standard +” may express a state where a predetermined display characteristic is increased from the standard state at other ratio such as 5%. The “standard ++” and “standard −” may be similarly changed at other ratio.

Although environment light is detected by using the CCD 303 and the like in each of the foregoing embodiments, the invention is not limited to the arrangement. For example, environment light may be detected by a sensor separately provided on the surface of the camera body 2 or the like.

Further, the invention can be applied not only a digital camera for taking mainly still pictures as in the embodiments but also to a video camera and the like capable of capturing moving pictures. That is, the “electronic camera” in the specification can be directed to capture any of still pictures and moving pictures.

While the invention has been shown and described in detail, the foregoing description in all aspects illustrative and not restrictive. It is therefore understood that numerous other modifications and variations can be devised without departing from the scope of the invention.

We claim:

1. An electronic camera comprising:
a display for displaying an image of a subject;
a detector for detecting environment light; and
a corrector for correcting an image displayed on said display by changing a display characteristic of the image displayed on said display in accordance with a state of the environment light detected by said detector.

2. The electronic camera according to claim 1, further comprising an ocular for making the user visually recognize an image displayed on said display.

3. The electronic camera according to claim 2, wherein said corrector changes brightness of an image displayed on said display in accordance with brightness of said environment light.

4. The electronic camera according to claim 3, wherein said corrector decreases brightness of an image displayed on said display as brightness of said environment light decreases.

5. The electronic camera according to claim 2, wherein said corrector changes hue of an image displayed on said display in accordance with hue of said environment light.

6. The electronic camera according to claim 5, wherein said corrector changes hue of an image displayed on said display in the direction opposite to hue of said environment light.

7. The electronic camera according to claim 5, wherein said corrector changes hue of an image displayed on said display in the direction same as hue of said environment light.

8. The electronic camera according to claim 2, wherein said corrector changes contrast in an image displayed on said display in accordance with brightness of said environment light.

9. The electronic camera according to claim 8, wherein said corrector increases contrast in an image displayed on said display as brightness of said environment light increases.

10. The electronic camera according to claim 9, wherein said corrector decreases brightness of an image displayed on said display as brightness of said environment light increases.

11. The electronic camera according to claim 2, further comprising an image pickup device for capturing an image of a subject,
wherein said detector detects brightness of environment light from exposure time, incident light amount, and sensitivity of said image pickup device.

12. The electronic camera according to claim 2, wherein said detector is a sensor different from said image pickup device.

13. An electronic camera comprising:
a first display capable of electrically displaying a captured image;
a second display capable of electrically displaying a captured image in a display mode different from that of said first display;
a detector for detecting a state of environment light; and
a controller for changing a display state of at least one of said first and second displays in accordance with the state of the environment light detected by said detector.

14. The electronic camera according to claim 13, wherein said first display has an ocular for making the user visually recognize an image displayed.

15. The electronic camera according to claim 14, further comprising a discriminator for discriminating whether brightness of said environment light is higher than a predetermined value,
wherein when it is discriminated by said discriminator that the brightness of said environment light is higher than said predetermined value, said controller makes said first display displayable.

16. The electronic camera according to claim 14, further comprising a discriminator for discriminating whether brightness of said environment light is higher than a predetermined value,
wherein when it is discriminated by said discriminator that the brightness of said environment light is higher than said predetermined value, said controller displays indication on said second display to notify the user to change said first display to a displayable state.

17. The electronic camera according to claim 14, further comprising an image pickup device for capturing an image of a subject,
wherein said detector detects brightness of environment light from exposure time, incident light amount, and sensitivity of said image pickup device.

18. The electronic camera according to claim 14, wherein said detector is a sensor different from said image pickup device.

19. An electronic camera capable of emitting flash light with which a subject is irradiated, comprising:
an image pickup device for capturing an image of the subject;
a first display capable of electrically displaying the image of the subject captured by said image pickup device;
a second display capable of electrically displaying the image of the subject captured by said image pickup device in a display mode different from that of said first display; and
a controller for controlling display on said first and second displays,
wherein said controller displays the image of the subject irradiated with said flash light onto said first display, and displays the image of the subject captured by said image pickup device onto said second display in predetermined cycles.

20. The electronic camera according to claim 19, wherein said first display has an ocular for making the user visually recognize an image displayed.

21. The electronic camera according to claim 20, wherein said controller displays the image of the subject irradiated with said flash light onto said first display for a predetermined period.

22. An electronic camera comprising:
a first display capable of electrically displaying a captured image;
a second display capable of electrically displaying the captured image in a display mode different from that of said first display; and
an adjuster for adjusting a gain of an image displayed on said first display and a gain of an image displayed on said second display,
wherein said adjuster amplifies the image displayed on said first display by a first gain and amplifies the image displayed on said second display by a second gain different from said first gain.

23. The electronic camera according to claim 22, wherein said first display has an ocular for making the user visually recognize an image displayed, and
said first gain is higher than said second gain.

24. The electronic camera according to claim 22, wherein said first display has an ocular for making the user visually recognize an image displayed, and
said first gain is lower than said second gain.
